(19) United States
(12) Patent Application Publication
(10) Pub. No.: US 2008/0196822 A1
(43) Pub. Date: Aug. 21, 2008

(54) Method Of Laminating Adherend

(76) Inventors: Kazuo Satoh, Tokyo (JP); Haruyuki Mikami, Tokyo (JP); Hideo Yamazaki, Tokyo (JP)

Correspondence Address: 3M INNOVATIVE PROPERTIES COMPANY, PO BOX 33427, ST. PAUL, MN, 55133-3427, US

(21) Appl. No.: 12/063,564

(22) PCT Filed: Aug. 8, 2006
(86) PCT No.: PCT/US06/30883

§ 371 Date: Feb. 11, 2008

(30) Foreign Application Priority Data
Aug. 12, 2005 (JP) 2005-234315

(51) Int. Cl. B29C 65/02

(52) U.S. Cl. 156/219

(57) ABSTRACT

There is provided a means for laminating and bonding a flexible printed circuit and a stiffener film with an adhesive layer therebetween by using a laminator without creating air bubbles at the lamination surface and without using large-scale manufacturing equipment. A method comprising: providing a laminate in which liners are on upper and lower surfaces of a half-cured reactive adhesive layer (3), removing one of the liners from the laminate, and bonding a surface of a first adherend (2) to the first exposed surface of the adhesive layer; removing the other liner from the laminate, pressure bonding a minute embossing pattern (4) surface of an embossed liner to the second exposed surface of the adhesive layer to form a minute embossing pattern on the surface of the adhesive layer; and removing the embossed liner from the surface of the adhesive layer, and thermocompression bonding a second adherend to the surface of the adhesive layer having the minute embossing pattern.

### BACKGROUND

The present invention relates to a method of laminating an adherend which rarely causes air bubbles to occur between the adherend and an adhesive layer.

In recent years, a flexible printed circuit (FPC) which is thin and flexible and has excellent flexural characteristics has been widely used as a circuit board for electrodynamic machines or electronic instruments, as a connection wiring board used in a movable section, as a wiring board used in a chip-level package, or the like. The FPC is generally formed by providing a circuit pattern on one side of a film-shaped base material. Since the film-shaped base material is formed of a polymer resin or the like having flexibility, the FPC exhibits flexural characteristics. The FPC is reinforced by thermocompression bonding a stiffener film to the FPC with an adhesive film provided therebetween at a high temperature of about 160° C. to bond the FPC and the stiffener film through the adhesive film.

However, if thermocompression bonding is insufficient, air bubbles occur between the adhesive film used for bonding the stiffener film and the FPC base material. This problem is not limited to the case of bonding the stiffener film to the FPC. Specifically, when laminating adherends through an adhesive film, if compression bonding is insufficient, or recesses and protrusions are formed at the bonding surface between the adherends, air bubbles can remain at the bonding surface.

As a means for removing air bubbles at the bonding surface, a method of absorbing the air bubbles using a vacuum device, or by applying pressure to the bonding surface using a roll device has been known (see patent document 1 relating to a technology for laminating a decorative film). However, this method requires large-scale manufacturing equipment.

### SUMMARY

The invention has been achieved in view of the above-described problems. An objective of the invention is to provide a means for bonding adherends with an adhesive film interposed therebetween without causing air bubbles to occur at the bonding surface. More particularly, an objective of the invention is to provide a means which is suitable for laminating and bonding adherends when the adherends consist of an FPC and a stiffener film, and can be carried out by using a general laminator or a thermocompression bonding device without causing air bubbles to occur at the lamination or bonding surface and without using large-scale manufacturing equipment. As a result of extensive studies, the present inventors have found that the above objectives can be achieved by the following means.

According to an aspect of the invention, there is provided a method of laminating an adherend, the method comprising: providing a laminate in which a flat base material is laminated on one surface of an adhesive layer of a half-cured (B stage) reactive adhesive and a minute embossing pattern is formed on the other surface of the adhesive layer; and thermocompression bonding an adherend to the other surface of the laminate on which the minute embossing pattern is formed (hereinafter may be called “first aspect”).

According to another aspect of the invention, there is provided a method of laminating an adherend, the method comprising: a first step of providing a laminate in which flat liners are provided on upper and lower surfaces of an adhesive layer of a half-cured reactive adhesive, removing one of the flat liners from the laminate, and bonding a flat surface of a first adherend to the surface (surface B) of the adhesive layer from which the flat liner has been removed; a second step of removing the other flat liner from the laminate, pressure bonding a minute embossing pattern surface of an embossed liner to the surface of the adhesive layer from which the other flat liner has been removed to form a minute embossing pattern on the surface of the adhesive layer; and a third step of removing the embossed liner from the surface of the adhesive layer, and thermocompression bonding a second adherend to the surface (surface A) of the adhesive layer on which the minute embossing pattern has been formed and from which the embossed liner has been removed (hereinafter may be called “second aspect”).

In the second aspect, it is preferable that the embossed liner having the minute embossing pattern surface be a liner in which continuous groove sections having a lattice pattern with a pitch of about 300 μm or less and a height of about 5 to about 30 μm are formed to reach side faces of the liner.

According to another aspect of the invention, there is provided a method of laminating an adherend, the method comprising: a first step of providing an embossed liner having a minute embossing pattern surface, and applying a half-cured (B stage) reactive adhesive to the minute embossing pattern surface of the embossed liner to form an adhesive layer in which a minute embossing pattern is formed on one surface; a second step of bonding a flat surface of a first adherend to the other surface (surface B) of the adhesive layer; and a third step of removing the embossed liner from the one surface of the adhesive layer, and thermocompression bonding a second adherend to the one surface (surface A) of the adhesive layer on which the minute embossing pattern has been formed and from which the embossed liner has been removed (hereinafter may be called “third aspect”).

In the third aspect, it is preferable that the embossed liner having the minute embossing pattern surface be a liner in which continuous groove sections having a lattice pattern with a pitch of about 300 μm or less and a height of about 5 to about 30 μm are formed to reach side faces of the liner.

The “method of laminating an adherend according to the invention” used herein refers to all of the first, the second, and the third aspects. In the specification, one of the two surfaces of the adhesive layer on which the minute embossing pattern is formed is called a surface A, and the surface on which the minute embossing pattern is not formed is called a surface B.

The method of laminating an adherend of the invention includes the step of forming the minute embossing pattern on the adhesive layer by using the embossed liner having the minute embossing pattern surface, and laminating one of the adherends on the surface (surface A) of the adhesive layer on which the minute embossing pattern has been formed. In the method of laminating an adherend according to the invention, a thermosetting adhesive may be used as the B stage adhesive which forms the adhesive layer, a base material made of a polymer resin having a thickness of 50 to 200 μm and a melting point of 200° C. or higher may be bonded to the surface B of the adhesive layer as the first adherend, and an FPC may be bonded to the surface A as the second adherend. According to this feature, the method of laminating an adherend of the invention can be used as a means suitable for reinforcing the FPC from the viewpoint of flexibility and heat resistance. The strength of the FPC can be adjusted without causing air bubbles to occur at the lamination surface between at least the surface (surface A) of the adhesive layer on which the minute embossing pattern is formed and the FPC merely by laminating the FPC and the base material on the adhesive layer using a general laminator or a thermocompression bonding device in thermocompression bonding in the third step.

In the method of laminating an adherend according to the invention, the minute embossing pattern is formed on the surface A of the adhesive layer by using the embossed liner having the minute embossing pattern surface in the second step in the second aspect and the first step in the third aspect. It is preferable that the minute embossing pattern be formed on a substantially flat surface, continuous groove sections having a lattice pattern be formed in the flat surface so as to reach side faces of the adhesive layer, and the groove sections have a lattice pattern pitch of 300 μm or less and a depth of 5 to 30 μm. It is preferable that the groove section be formed so that the width of the groove section is continuously reduced from the open surface toward the bottom section, the width at the open surface be 10 to 30 μm, and the width at the bottom section be 0 to 5 μm. If the minute embossing pattern has such a feature, a fluid such as air is easily removed (is not confined) through the groove section. The statement “substantially flat surface” used herein means that the surface is mainly formed as a flat surface, and that the flat surface exists between the groove sections and the surface is flat excluding the groove sections or the like. The open surface is an insubstantial surface and is a surface equivalent to the surface (flat surface) of the adhesive layer when the groove section does not exist.

The embossed liner having the minute embossing pattern surface for forming the minute embossing pattern at the surface A of the adhesive layer is an embossed liner on which projection sections which engage the groove sections of the minute embossing pattern are formed. In the method of laminating an adherend according to the invention, since the embossed liner is laminated on the surface A of the adhesive layer until the embossed liner is thermocompression bonded to the second adherend in the third step, the groove section is not deformed even if the adhesive layer is formed of a half-cured (B stage) thermo-setting adhesive. Therefore, the effect of causing air to be removed and the groove section to be undetected after lamination can be securely obtained by removing the embossed liner immediately before lamination (third step).

In the method of laminating an adherend according to the invention, it is preferable to form projection sections disposed at almost equal intervals on the surface A of the adhesive layer in addition to the groove sections. The position can be adjusted by contacting and sliding the protrusion sections on the surface of the second adherend before applying sufficient pressure to laminate (completely bond) the second adherend in the third step. Therefore, positioning can be performed more accurately and more easily when laminating the second adherend (e.g. FPC) on the adhesive layer (surface A).

In the method of laminating an adherend according to the invention, the thermocompression bonding in the third step is preferably performed using a laminator under conditions of a roll temperatures of 80 to 95° C., a roll speed of 0.5 to 1.5 m/min, and a pressure of 200 to 400 kPa.

In the method of laminating an adherend according to the invention, a cover lay film, a dry film, an FPC, or the like may be used as the first adherend, and a base material, an FPC, or the like may be used as the second adherend. The method of laminating an adherend of the invention is suitably utilized when the first adherend is an integrated circuit (IC) chip and the second adherend is a base material (including a lead frame) or when the first adherend is a heat sink on a semiconductor and the second adherend is one surface (e.g. top surface) of the semiconductor, so that the first adherend and the second adherend can be bonded (thermocompression bonded) without causing air bubbles to occur between the first adherend and the second adherend.

The method of laminating an adherend of the invention enables the adherend to be laminated on the adhesive layer without causing air bubbles to occur at the lamination surface between the adherend and the adhesive layer. In more detail, since the method of laminating an adherend of the invention forms a minute embossing pattern on the adhesive layer by using the embossed liner having the minute embossing pattern surface, the minute embossing pattern causes a fluid such as air to be removed through the space between the adherend and the adhesive layer when the adherend (e.g. FPC) is laminated on the surface (surface A), and the adhesive layer in a B stage sufficiently adheres to the adherend.

### BRIEF DESCRIPTION OF THE DRAWINGS

FIG. 1 is a side view showing one embodiment of an embossed adhesive film according to the invention.

FIG. 2 is a plan view of the embossed adhesive film shown in FIG. 1.

FIG. 3 is an enlarged view of a groove section of the embossed adhesive film shown in FIG. 1.

FIG. 4 is an enlarged view of a groove section of the embossed adhesive film shown in FIG. 1.

FIG. 5 is a plan view showing another embodiment of an embossed adhesive film according to the invention.

FIG. 6 is an enlarged view of a groove section and a projection section of the embossed adhesive film shown in FIG. 5.

FIG. 7 is an enlarged view of a groove section of the embossed adhesive film shown in FIG. 5.

FIG. 8 is an enlarged view of a groove section and a projection section of the embossed adhesive film shown in FIG. 5.

FIG. 9 is an enlarged view of a projection section of the embossed adhesive film shown in FIG. 5.

FIG. 10 is a plan view showing yet another embodiment of an embossed adhesive film according to the invention.

FIG. 11 is an enlarged view of the surface of an adhesive layer of the embossed adhesive film shown in FIG. 10.

FIGS. 12(a) to 12(e) are explanatory diagrams of steps of an FPC stiffener film lamination method according to the invention.

### DETAILED DESCRIPTION

Embodiments of the present invention are described below with reference to the drawings. However, the present invention should not be construed as being limited to the following embodiments. Various alterations, modifications, and improvements may be made within the scope of the present invention based on knowledge of a person skilled in the art. For example, although the drawings show preferred embodiments of the invention, the invention is not limited to modes shown in the drawings or to information given in the drawings. Although means similar to or equivalent to means described in the specification may be applied when carrying out or verifying the invention, preferable means are means as described herein.

A method of laminating an adherend according to the invention includes a step of bonding an adherend (first adherend) having a flat surface to the surface (surface B) of the adhesive layer on which a minute embossing pattern is not formed, and a step of forming a minute embossing pattern on the adhesive layer by using an embossed liner having a minute embossing pattern surface, and thermocompression bonding an adherend (second adherend) to the surface (surface A) of the adhesive layer on which the minute embossing pattern has been formed. In the method of laminating an adherend according to the invention, a film-shaped base material such as a cover lay film or a dry film may be suitably used as the first adherend having a flat surface, and the first adherend is bonded to the surface B of the adhesive layer and the minute embossing pattern is formed on the surface A of the adhesive layer by using the embossed liner before thermocompression bonding the second adherend to the surface A of the adhesive layer. In the specification, a film in which the film-shaped base material (first adherend) is bonded to the surface B of the adhesive layer and the minute embossing pattern is formed on the surface A of the adhesive layer is called an embossed adhesive film according to the invention. The embossed adhesive film according to the invention is described below.

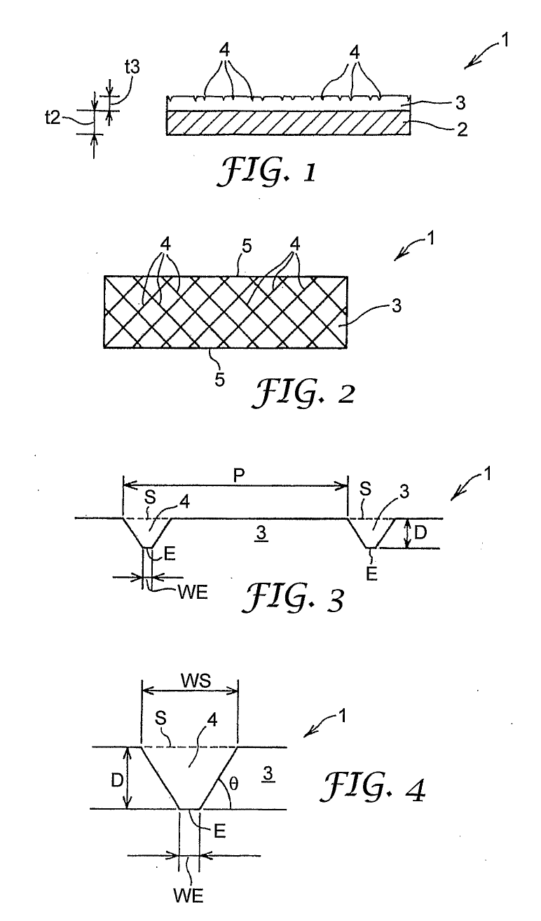

FIGS. 1 to 4 are diagrams showing one embodiment of an embossed adhesive film according to the invention. FIG. 1 is a side view showing a side face, FIG. 2 is a plan view showing an adhesive layer, FIGS. 3 and 4, showing the surface of the adhesive layer, are enlarged views of a groove section in the cross section perpendicular to the longitudinal direction of the groove section.

An embossed adhesive film 1 shown in the drawings includes a base material layer 2 (layer formed by film-shaped base material) and an adhesive layer 3 laminated on the base material layer 2. The surface of the adhesive layer 3 on the side opposite to the base material layer 2 is a substantially flat surface, and continuous groove sections 4 disposed in a lattice pattern are formed to reach side faces 5 of the adhesive layer 3. It is preferable that an embossed liner (not shown), having projection sections that form the groove sections 4, be further laminated on the surface of the adhesive layer 3 opposite to the base material layer 2. The embossed liner is then removed from the embossed adhesive film 1.

The lattice pattern is an example of a minute embossing pattern formed by providing the groove sections 4 to intersect, as shown in FIG. 2. However, the lattice pattern is not limited to a pattern in which each grid forms a square as in the embossed adhesive film 1 insofar as the pattern is in the shape of a lattice. The embossment represents a state in which grooves and projections exist due to formation of the groove sections 4. The continuous groove section 4 refers to a groove continuously formed in the shape of a stripe. The statement “formed to reach side faces 5 of the adhesive layer 3” means a state in which the continuous groove section 4 is formed to reach the side faces 5 of the adhesive layer 3 and is open at the side faces 5 so that the groove section 4 can be seen at the side faces 5 (see FIG. 1).

In the embossed adhesive film 1, a thickness t2 of the base material layer 2 is typically 50-200 μm and in at least one embodiment is 125 μm, and a thickness t3 of the adhesive layer 3 is typically 15-100 μm and in at least one embodiment is 40 μm (see FIG. 1).

The material for the base material layer 2 of the embossed adhesive film 1 is not limited insofar as the material exhibits heat resistance. The statement “the material exhibits heat resistance” means that the material exhibits heat resistance even at a temperature higher than 200° C. encountered in a solder reflow step or the like. A preferable material for the base material layer is a resin material such as polyimide or glass epoxy or a metal material such as copper, stainless steel, or aluminum.

The adhesive layer 3 of the embossed adhesive film 1 is formed by a reactive adhesive in a B stage, such as an epoxy adhesive which is a thermo-setting adhesive. The thermo-setting adhesive undergoes a reaction due to heat to exhibit an adhesive performance, differing from a pressure sensitive adhesive (tackiness agent). A polyester, phenol, or polyurethane thermo-setting adhesive may be used instead of the epoxy thermosetting adhesive. A thermoplastic adhesive may also be used as the reactive adhesive in a B stage. However, the epoxy thermo-setting adhesive is still more preferable.

In the embossed adhesive film 1, it suffices that the pitch of the lattice pattern be 300 μm or less between arbitrary groove sections. The pitch of the lattice pattern is preferably 250 μm or less, and still more preferably 200 μm or less. The depth of the groove section is preferably 5 to 30 μm, and more preferably 8 to 12 μm. In at least one embodiment the groove sections 4 have a lattice pattern pitch P of 197 μm, and have a depth D of 10 μm. The pitch P refers to the distance between the adjacent groove sections 4, and the depth D of the groove section 4 refers to the distance from an open surface S to a bottom section E (deepest section).

In the embossed adhesive film 1, the groove section 4 is formed so that the width of the groove section 4 is continuously reduced from the open surface S toward the bottom section E. It suffices that the width at the open surface 5 be 10 to 30 μm, the width at the bottom section E be 0 to 5 μm, and the angle theta (θ) be 7 to 90°. In at least one embodiment, the groove section 4 has an angle theta (see FIG. 4) of 60°, a width WS at the open surface S of 14 μm, and a width WE at the bottom section E of 3 μm. The angle theta is determined by (ratio of) these widths. The width used herein refers to the distance in the lateral direction of the groove section which is a groove continuously formed in the shape of a stripe, as indicated by the width WS and the width WE. The open surface is an insubstantial surface and is a surface equivalent to the flat surface of the adhesive layer opposite to the base material layer where the groove section does not exist. The width at the open surface 5 is preferably 15 to 25 μm. The bottom section refers to a section including the deepest section (viewed from the open surface) of the groove section, as indicated by the bottom section E. A case where the width at the bottom section is “0” means that, when the cross-sectional shape of the groove section in the lateral direction (see FIGS. 3 and 4) has vertices, the groove section has an inverted triangular cross-sectional shape, for example. When the width at the bottom section is greater than “0” as in the embossed adhesive film 1, the bottom section forms a predetermined surface so that the cross-sectional shape of the groove section in the lateral direction is a trapezoid (upper side is longer). The width at the bottom section is preferably 2 to 4 μm.

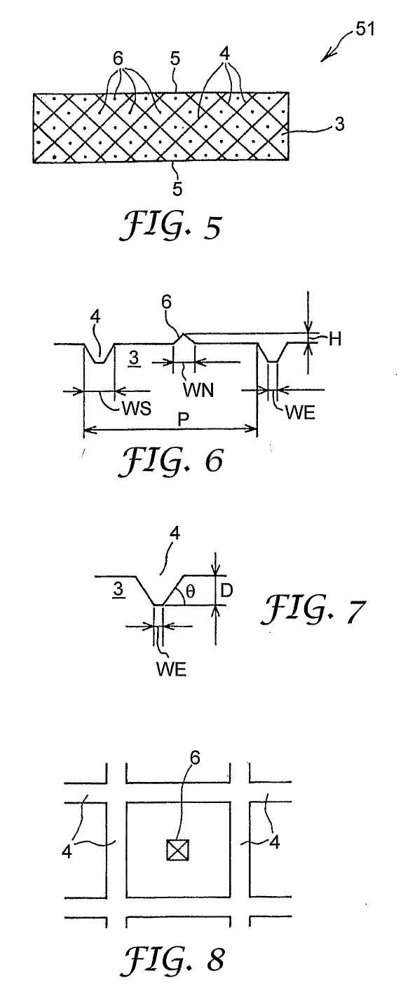

FIGS. 5 to 9 are diagrams showing another embodiment of an embossed adhesive film according to the invention. FIG. 5 is a plan view showing the side of an adhesive layer, FIGS. 6, 7, and 9, showing the surface of the adhesive layer, are enlarged views of a groove section and a projection section in the cross section perpendicular to the longitudinal direction of the groove section, and FIG. 8 is an enlarged plan view of the groove section and the projection section. A side view of the side face is omitted.

An embossed adhesive film 51 shown in the drawings includes the base material layer (not shown) and the adhesive layer 3 laminated on the base material layer in the same manner as the above-described embossed adhesive film 1. The surface (surface A) of the adhesive layer 3 on the side opposite to the surface (surface B) on the side of the base material layer is a substantially flat surface, and the continuous groove sections 4 disposed in a lattice pattern are formed to reach the side faces 5 of the adhesive layer 3. It is preferable that an embossed liner (not shown), having projection sections that form the groove sections 4, be further laminated on the surface of the adhesive layer 3 on the side opposite to the base material layer. The embossed liner is then removed from the embossed adhesive film 51.

The embossed adhesive film 51 differs from the embossed adhesive film 1 in that projection sections 6 disposed at almost equal intervals are formed on the surface (surface A) of the adhesive layer 3 on the side opposite to the base material layer. The remaining features are the same as those of the embossed adhesive film 1. Therefore, further description is omitted.

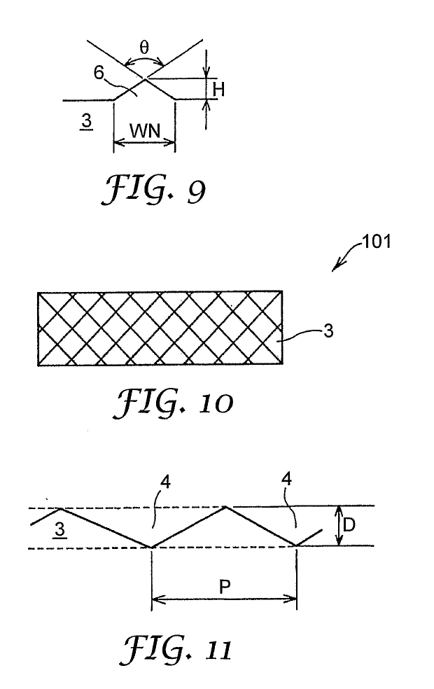

In the embossed adhesive film 51, the projection section 6 is in the shape of a pyramid (see FIGS. 8 and 9). The projection section 6 is provided at the center of an area enclosed by the groove sections 4 of the lattice pattern formed by causing the groove sections 4 to intersect (area corresponding to the grid) (see FIGS. 5 and 8). In the embossed adhesive film 51, it is preferable that the projection section be in the shape of a pyramid. The projection section may be in the shape of a cone. The number of projection sections is not limited insofar as the projection sections are disposed at approximately equal intervals.

In the embossed adhesive film 51, it suffices that the projection section have a width WN of 5 to 50 μm, a height H of 5 to 15 μm, and an angle phi (φ) of 20 to 180°. In at least one embodiment the projection section 6 has a width WN of 38 μm, a heights H of 10 μm, and an angle phi of 125°. The angle phi is determined by the width and the height of the projection.

In the embossed adhesive films 1 and 51, the surface (surface A) of the adhesive layer opposite to the base material layer is substantially flat. This means that a flat surface exists between the groove sections and the like, and the surface A is flat excluding the groove sections (and the projection sections). FIGS. 10 and 11 show another embodiment.

FIGS. 10 and 11 are diagrams showing still another embodiment of an embossed adhesive film according to the invention. FIG. 10 is a plan view showing the side of an adhesive layer (similar to FIGS. 2 and 5), and FIG. 11 is an enlarged diagram of the surface of the adhesive layer (similar to FIGS. 3 and 6). An embossed adhesive film 101 shown in the drawings includes the base material layer and the adhesive layer 3 laminated on the base material layer. Grooves and projections are formed at the surface of the adhesive layer 3 opposite to the base material layer 2 so that a flat surface does not exist between the groove sections 4. In other words, the surface of the adhesive layer 3 which is the substantial section is formed by a series of projection sections in the shape of a cone or pyramid. In the embossed adhesive film 101, the pitch P of groove section 4 is preferably 10 μm to 300 μm and the depth D of groove section 4 is preferably 5 μm to 30 μm.

A method of laminating an adherend according to the invention is described below based on specific embodiments. The following embodiment illustrates the case where an adhesive film is used as an adhesive layer, a first adherend is a base material film, and a second adherend is a flexible printed circuit. This embodiment is called a FPC stiffener film lamination method according to the invention.

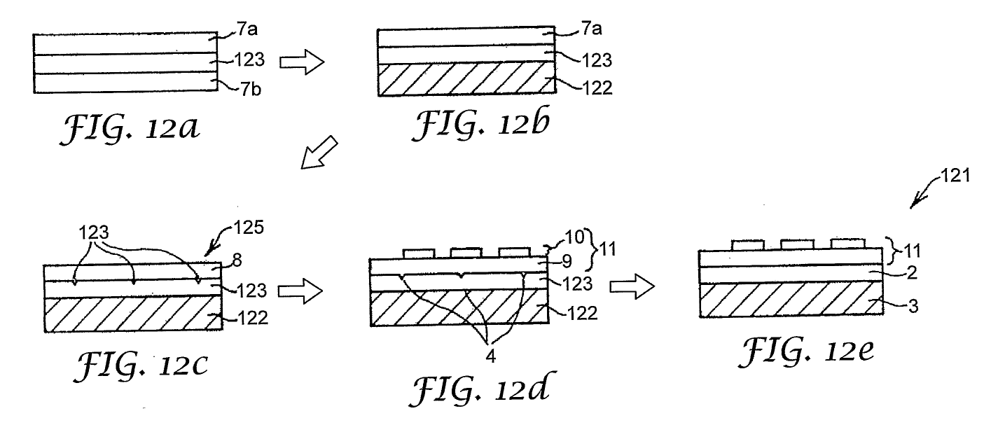

FIG. 12 is a diagram showing one embodiment of the FPC stiffener film lamination method according to the invention. FIG. 12 shows steps of the method in the order of (a) to (e) as indicated by the arrows. A flat adhesive film 123 formed of a thermo-setting adhesive and provided with flat liners 7a and 7b on either side is provided (see (a) in FIG. 12). The adhesive film 123 is a film which forms an adhesive layer. The adhesive film 123 may be prepared, or a commercially available product may be used as the adhesive film 123. An adhesive film made of a thermo-setting polymer resin such as an epoxy resin, a polyester resin, a phenolic resin, or a polyurethane resin is commercially available. The adhesive film 123 may be a thermoplastic adhesive film. The thickness of the adhesive film 123 differs depending on the composition of the adhesive film 123, the type of an embossed liner described later, the type of the FPC as the adherend, and the like. A person skilled in the art may arbitrarily adjust the thickness of the adhesive film 123. A preferable thickness is 30 to 200 μm.

The flat liner 7b on one side of the adhesive film 123 is removed, and a base material film 122 is laminated on the side of the adhesive film 123 from which the flat liner 7b is removed (see (b) in FIG. 12). The base material film 122 is a film which forms a base material layer. Since the base material film 122 is subjected to a high temperature of 200° C. or more in a solder reflow step, the base material film 122 exhibiting heat resistance is used. The base material film 122 may be prepared, or a commercially available product may be used as the base material film 122. A film exhibiting excellent heat resistance made of a resin material such as polyimide or glass epoxy, a metal material such as copper, stainless steel, or aluminum, or the like is commercially available. The thickness of the base material film 122 is preferably 50 to 200 μm.

A primer may be used to increase the adhesion between the adhesive film 123 and the base material film 122. The type of the primer differs depending on the type of the materials for the adhesive film 123 and the base material film 122. A person skilled in the art may select an appropriate primer (see patent document 4).

After removing the flat liner 7a from the other side of the adhesive film 123, an embossed liner 8 having a minute embossing pattern surface, on which projection sections 124 are formed, is pre-laminated on the side of the adhesive film 123 from which the flat liner 7a is removed, and the embossed liner 8 is thermocompression-bonded to the adhesive film 123, preferably by using a laminator (see (c) in FIG. 12). When thermocompression bonding the embossed liner 8, the laminator used is preferably set at a roll temperature of 80 to 95° C., a roll speed of 0.5 to 1.5 m/min, and a pressure of 200 to 400 kPa. An embossed adhesive film 125 with the embossed liner 8, in which groove sections are formed in the adhesive film 123, can be obtained by these steps. The embossed adhesive film 125 is an FPC stiffener film of which the base material film 122 has a reinforcement function.

An embossed liner having groove sections disposed at approximately equal intervals may be used as the embossed liner 8. To form projection section 124, slurry prepared by mixing a thermo-setting adhesive of the same material as the adhesive film and beads may be provided to the groove sections to form projection sections on the adhesive film (see patent document 3).

The projection section 124 forms a groove section 4 in the adhesive film 123 (see (d) in FIG. 12). The projection sections 124 are provided in a lattice pattern and continuously formed to reach the side faces of the embossed liner 8. The projection sections 124 are formed so that the pitch of the lattice pattern is 300 μm or less and the height of the projection section is 5 to 30 μm. The projection section 124 is preferably formed so that the width of the projection section 124 is continuously reduced from the bottom surface toward the vertex, the width at the bottom surface is 10 to 30 μm, and the width at the vertex is 0 to 5 μm.

The embossed liner 8 may be formed by subjecting a flat release liner, made of a polymer resin material such as polyethylene, polypropylene, or polyvinyl chloride, or another material coated with such a polymer resin material, to embossing processing using a heated embossing roll or the like to form the projection sections 124 (see patent document 2). The embossed liner 8 may be formed by using a technology disclosed in the patent document 5. The embossed liner 8 is preferably provided with improved release properties by subjecting the embossed liner 8 to release processing.

A separately provided flexible printed circuit 11 having a circuit pattern layer 10 and a base material layer 9 is bonded to the embossed adhesive film 125. This step is carried out by removing the embossed liner 8 from the embossed adhesive film 125, pre-laminating the surface of the embossed adhesive film 125, on which the groove sections 4 are formed, on the base material layer 9 of the flexible printed circuit 11, and thermocompression bonding the embossed adhesive film 125 by using a laminator (see (d) in FIG. 12). In this step, the laminator is preferably set at a roll temperatures of 80 to 95° C., a roll speed of 0.5 to 1.5 m/min, and a pressure of 200 to 400 kPa. A fluid (air) confined in the groove section 4 is caused to flow toward the outside of the system by pressing the flexible printed circuit 11 against the embossed adhesive film 125 at this setting, whereby air bubbles can be removed. In this case, all the groove sections 4 in the adhesive film 123 flatten to increase the contact area between the flexible printed circuit 11 and the adhesive film 123, whereby a desired bond strength is obtained and the entire appearance is improved.

A flexible printed circuit 121 reinforced by the base material layer 2 can be obtained by these steps (see (e) in FIG. 12). In the reinforced flexible printed circuit 121, the base material layer 2 is formed by the base material film 122, and the adhesive layer 3 is formed by the adhesive film 123. In the above-described embodiment, an adhesive film in which a minute embossing pattern is formed can also be obtained by directly applying an adhesive to the embossed liner 8 in the shape of a film without using the adhesive film 123 and the flat liner 7a.

### EXAMPLES

The invention is described below in detail based on examples.

### Example 1

A polyimide film with a thickness of 125 μm (manufactured under the trade name APICAL NPI by Kaneka Corporation), an epoxy adhesive film with a thickness of 40 μm (manufactured under the trade name NIKAFLEX SAFW by Nikkan Industries Co., Ltd.), an FPC (prepared by plating copper to a thickness of 12 μm on a polyimide film with a thickness of 25 μm (manufactured under the trade name KAPTON E by DuPont-Toray Co., Ltd.) by an additive method) were provided. A flat release liner made of polyethylene (manufactured by Tomoegawa Paper Co., Ltd.) was provided, and subjected to embossing processing by using an embossing machine to prepare an embossed liner on which projection sections were formed. Incidentally, the embossed liner was produced in such a manner that an adhesive film later subjected to embossing processing with the embossed liner might have a minute embossing pattern having P of 197 μm and D of 10 μm in FIG. 3 and theta of 60°, WE of 3 μm, and WS of 14.5 μm in FIG. 4.

After removing the flat liner from one side of the epoxy adhesive film, the polyimide film was bonded to the side of the epoxy adhesive film from which the flat liner was removed. After removing the flat liner from the other side of the epoxy adhesive film, the embossed liner was pre-laminated on the side of the epoxy adhesive film from which the flat liner was removed, and subjected to thermocompression bonding using a laminator at a roll temperature of 90° C., a roll speed of 1 m/min, and a pressure of 300 kPa to obtain an embossed adhesive film. The resulting embossed adhesive film was similar to the embossed adhesive film 1 shown in FIGS. 1 to 4.

The resulting embossed adhesive film was cut to a size of 38×8.1 mm. After removing the embossed liner, the embossed adhesive film was pre-laminated on the FPC, and subjected to thermocompression bonding using a laminator at a roll temperature of 90° C., a roll speed of 1 m/min, and a pressure of 300 kPa to obtain a reinforced flexible printed circuit.

The presence or absence of air bubbles in the resulting reinforced flexible printed circuit was examined (examination 1). After subjecting the resulting reinforced flexible printed circuit to pre-curing at 80° C. for 30 min and curing at 160° C. for 60 min, the presence or absence of air bubbles in the reinforced flexible printed circuit was examined (examination 2). The results are shown in Table 1. The examination was carried out by naked eye observation conducted by five persons. The presence or absence of air bubbles was evaluated as a ratio “number of persons who recognized air bubbles/total number of persons (five persons)”, and the size of the air bubbles is also indicated in Table 1.

### Example 2

A reinforced flexible printed circuit was obtained in the same manner as in Example 1 except for thermocompression bonding the embossed adhesive film by using a thermocompression bonding device instead of the laminator at a heating plate temperature of 150° C., a pressure of 500 kPa, and a thermocompression bonding time of 30 sec. After subjecting the flexible printed circuit to pre-curing and curing, the presence or absence of air bubbles was examined. The results are shown in Table 1.

### Example 3

Using the same method of processing the embossed liner, embossing machine, liner, and other materials as in Example 1, projection sections were formed on an epoxy adhesive film. The resulting embossed adhesive film was similar to the embossed adhesive film 51 shown in FIGS. 5 to 9. Incidentally, the embossed liner was produced in such a manner that an adhesive film later subjected to embossing processing with the embossed liner might have a minute embossing pattern having P of 197 μm, WS of 20 μm, WE of 3 μm, theta of 60°, D of 15 μm, WN of 38 μm, and H of 10 μm in FIGS. 5 to 9. A reinforced flexible printed circuit was obtained in the same manner as in Example 1. After subjecting the flexible printed circuit to pre-curing and curing, the presence or absence of air bubbles was examined. The results are shown in Table 1.

### Comparative Example 1

A reinforced flexible printed circuit was obtained in the same manner as in Example 1. However, after removing the flat liner from one side of the epoxy adhesive film, the polyimide film was bonded to the side of the epoxy adhesive film without using the embossed liner to obtain an adhesive film formed only of a flat surface. After removing the flat liner from the other side of the epoxy adhesive film, the epoxy adhesive film was pre-laminated on the FPC, and subjected to thermocompression bonding using the laminator. After subjecting the flexible printed circuit to pre-curing and curing according to Example 1, the presence or absence of air bubbles was examined. The results are shown in Table 1.

TABLE 1

| | |
|---|---|
| Examination 1 | Examination 2 |

| | | | | |
|---|---|---|---|---|
| Example 1 | 0/5 | | 0/5 | |
| Example 2 | 0/5 | | 0/5 | |
| Example 3 | 0/5 | | 0/5 | |
| Comparative | 5/5 | Large air | 5/5 | Large air |
| Example 1 | | bubble | | bubble |

(Consideration) As shown in Table 1, the results of Examples 1 to 3 suggest that excellent air bleeding properties were obtained so that an excellent appearance was provided due to the absence of air bubbles. In Comparative Example 1, occurrence of air bubbles was confirmed by all persons.

The method of laminating an adherend according to the invention can be suitably used as a means for laminating a stiffener film on a flexible printed circuit. The method of laminating an adherend according to the invention can also be suitably used as a means for laminating a cover lay film or a dry film used during circuit pattern formation. The method of laminating an adherend according to the invention can also be suitably used as a means for laminating and securing a heat sink on the top surface of a semiconductor or a means for securing an integrated circuit (IC) chip on a flexible printed circuit.

What is claimed is:

1. A method of laminating an adherend, the method comprising:
providing a laminate in which a flat base material is laminated on one surface of an adhesive layer of a half-cured reactive adhesive and a minute embossing pattern is formed on the other surface of the adhesive layer; and
thermocompression bonding an adherend to the other surface of the laminate on which the minute embossing pattern is formed.

2. A method of laminating an adherend, the method comprising:
a first step of providing a laminate in which flat liners are provided on upper and lower surfaces of an adhesive layer of a half-cured reactive adhesive, removing one of the flat liners from the laminate, and bonding a flat surface of a first adherend to the surface of the adhesive layer from which the flat liner has been removed;
a second step of removing the other flat liner from the laminate, pressure bonding a minute embossing pattern surface of an embossed liner to the surface of the adhesive layer from which the other flat liner has been removed to form a minute embossing pattern on the surface of the adhesive layer; and
a third step of removing the embossed liner from the surface of the adhesive layer, and thermocompression bonding a second adherend to the surface of the adhesive layer on which the minute embossing pattern has been formed and from which the embossed liner has been removed.

3. The method as defined in claim 2, wherein the embossed liner having the minute embossing pattern surface is a liner in which continuous groove sections having a lattice pattern with a pitch of 300 pm or less and a height of 5 to 30 μm are formed to reach side faces of the liner.

4. A method of laminating an adherend, the method comprising:
a first step of providing an embossed liner having a minute embossing pattern surface, and applying a half-cured reactive adhesive to the minute embossing pattern surface of the embossed liner to form an adhesive layer in which a minute embossing pattern is formed on one surface;
a second step of bonding a flat surface of a first adherend to the other surface of the adhesive layer; and
a third step of removing the embossed liner from the one surface of the adhesive layer, and thermocompression bonding a second adherend to the one surface of the adhesive layer on which the minute embossing pattern has been formed and from which the embossed liner has been removed.

5. The method as defined in claim 4, wherein the embossed liner having the minute embossing pattern surface is a liner in which continuous groove sections having a lattice pattern with a pitch of 300 μm or less and a height of 5 to 30 μm are formed to reach side faces of the liner.
